(19) United States
(12) Patent Application Publication
(10) Pub. No.: US 2017/0207530 A1
(43) Pub. Date: Jul. 20, 2017

(54) DEVICES, SYSTEMS AND METHODS FOR AIMING DIRECTIONAL ANTENNAS

(71) Applicant: TAOGLAS GROUP HOLDINGS, Enniscorthy (IE)

(72) Inventor: Christopher M. ANDERSON, Minneapolis, MN (US)

(21) Appl. No.: 15/397,061

(22) Filed: Jan. 3, 2017

Related U.S. Application Data
(60) Provisional application No. 62/278,684, filed on Jan. 14, 2016.

(51) Int. Cl. H01Q 3/24; H01Q 3/02; H04B 7/08; H04B 17/20; H01Q 1/22; H01Q 1/24

(52) U.S. Cl. CPC H01Q 3/24; H01Q 1/2291; H01Q 1/246; H04B 7/0814; H04B 17/20; H01Q 3/02

(57) ABSTRACT

Disclosed are devices, systems and methods that mix using an omnidirectional and directional antenna to ensure a minimum performance of the omnidirectional antenna while creating the possibility that the directional antenna will find the optimal direction to point and thus increase signal levels over what the omnidirectional antenna would provide by itself. This allows higher signal levels which results in more reliable communication and higher data throughput.

### CROSS-REFERENCE

This application claims the benefit of U.S. Provisional Application No. 62/278,684, filed Jan. 14, 2016, entitled Devices, Systems and Methods for Aiming Directional Antenna, which application is incorporated herein by reference.

### BACKGROUND

Currently mobile devices, Wifi clients and a wide variety of other radio systems use omnidirectional antennas, that is, non-directional antennas, because the devices do not know which way to point a directional antenna, and using a directional antenna pointed the wrong way results in lower signal level (or generally poorer performance) than using an omnidirectional antenna.

Without knowledge of the location of a remote station, a default antenna selection would typically be an omnidirectional or at least minimally directional antenna (MDA), such as a non-directional antenna (NDA). The signal of an MDA, however, is relatively weak compared to a highly directional antenna and therefore of a lower quality. This lower quality signal can have several shortcomings, including, for example, limiting the data throughput in schemes employing multiple bit-rates based on data quality. By contrast, a high gain, highly directional antenna, if aimed directly at the remote station can provide a strong, high quality signal with several practical advantages including maximizing data throughput rates in a multiple bitrate communications scheme and minimizing missed transmissions.

Without knowledge of the location of remote station, the disadvantages of the high gain directional antenna become most pronounced, providing poor quality signal in every orientation other than where it is specifically pointing.

Current antenna pointing methodologies or algorithms rely on prior knowledge of the location of the remote end of a communication link and physical orientation of the local antenna, or use an absolute or relative signal strength measurement from a single antenna. For instance, 802.11b implements antenna diversity by switching between two antennas very quickly. When an incoming message is detected, the receiver switches between the two antennas, taking a signal strength measurement from each antenna at a known point in the message preamble. The antenna with the higher quality signal is the antenna used for the remainder of the message.

Fixed or moving implementations of a radio link (such as fixed Wi-Fi clients talking to a fixed remote station) where the client uses a high gain directional antenna would benefit from being able to point that antenna without prior knowledge of the remote radio's location. What is needed, therefor, is a system that provides for automatically pointing a directional antenna without user intervention while maintaining the minimum level of performance offered by a non or minimally directional antenna.

### SUMMARY

The disclosed system solves a tradeoff in the selection of antenna type for maximizing signal quality and data throughput in wireless communication systems. This method and associated hardware allows for a simple method that automatically points a directional antenna without user intervention and without the link performance dropping below that supplied by the non-directional antenna. This system and method is of particular use in radio systems which support multiple symbol or bit rates such that messages may still be exchanged over a poor link but improving the link budget allows for increased throughput.

By autonomously controlling the directional antenna and comparing the relative signal quality to that of a non-directional antenna, a search and optimization scheme which selects the output antenna feed that offers the highest quality signal and thus superior antenna system performance can be achieved. At its worst, while in search mode, the output of the system will be the non-directional feed. Otherwise, the method will allow for the higher quality signal of the directional antenna pointing directly at the remote station. This allows higher signal levels which results in more reliable communication and higher data throughput.

In some configurations, two antennas of two different directionalities are used, in other configurations, a directional antenna is paired with a non-directional antenna.

An aspect of the disclosure is directed to a tunable communication device. Suitable devices comprise: a first antenna having a first directionality, in communication with a remote end of a wireless communications link having an unknown location; a second antenna having a second directionality greater than the first directionality on the order of 3 dB or more, in communication with the remote end of the wireless communications link wherein the second antenna is configurable to be steered so as to aim towards the remote end of the wireless communications link; an antenna driver configured to control an orientation of the second higher directivity antenna; and a comparator algorithm configured to evaluate the received signal quality from each of the first antenna and the second antenna and to compare at least one signal input from each of the first antenna and the second antenna to generate a feedback signal to instruct the antenna driver to steer the second antenna towards an orientation, wherein the comparator algorithm determines a quality of each of a first input from the first antenna and a second input from the second antenna to identify which of the first input and the second input has a higher quality and further wherein if the first antenna signal is of higher quality, the first antenna signal is selected and a line feed is routed to the output where a set of search and optimization instructions are executed and the antenna driver is adjusted to an orientation of the second antenna, and if the second antenna signal is of higher quality then the second antenna signal is selected. In some configurations, the second antenna is electronically steerable without the use of moving parts by the driver signal received from the antenna driver. Additionally, the second antenna can be physically steerable by actuating one or more actuators in response to the driver signal from the antenna driver. Additionally, the first antenna may be configured to plug into a housing containing the second antenna. In some configurations, the second antenna can be steered through multiple degrees of freedom. The remote station can be a Wi-Fi access point or a cellular base station. Depending on the application, the antenna can be steered through 1 to 3 degrees of freedom. For example, a satellite would use 3 degrees of freedom.

An additional aspect of the disclosure is directed to a tunable communication device comprising: a non or minimally directional antenna, in communication with a Wi-Fi access point having an unknown location generating a first signal; a second antenna, in communication with the Wi-Fi access point, wherein the second antenna is configured to be physically, angularly incremented and decremented to point towards the Wi-Fi access point generating a second signal; an antenna driver configured to control an orientation of the second antenna; and a comparator algorithm, configured to evaluate three or more of a current first signal quality, a prior first signal quality, a current second signal quality, and a prior second signal quality, and generate a feedback signal to an output based on a signal quality of the evaluated signals, wherein if the quality of either of the current first signal or prior first signal from the non-directional antenna has a higher quality than either of the current second signal or prior second signal from the second antenna, one of the current first signal or prior first signal is selected as a line feed and routed to the output if a set of search and optimization instructions are executed.

Still another aspect of the disclosure is directed to methods of operating a tunable communication device. Suitable methods comprise the steps of: receiving a first signal from a first non-directional antenna; receiving a second signal from a second, directional antenna; determining a quality of the first signal and a quality of the second signal; outputting a feed of a higher quality signal selected from the first signal and the second signal; and wherein if the first signal is selected an optimization protocol is performed. Methods can also include the step of: (a) altering a direction, orientation or polarization of the second antenna; (b) receiving a subsequent signal from the second antenna; and (c) determining a quality of the subsequent signal from the second antenna, wherein if a quality of the subsequent signal of the second antenna is lower than the quality of the signal from the first antenna, repeating steps (a) through (c). Additional steps can include one or more of: incrementally refining a directional antenna orientation angle or polarization when the signal quality of the first antenna is equal to or greater than the signal quality of the second antenna; and/or monitoring a relative quality of the second antenna signal and the first antenna signal, wherein if the first antenna signal strength exceeds the second antenna signal strength the step of analyzing is repeated.

Yet another aspect of the disclosure is directed to tunable communication devices comprising: a first antenna means having a first directivity, in communication with a remote end of a wireless communications link having an unknown location; a second antenna means having a second directivity greater than that of the first antenna's directivity, in communication with the remote end of the wireless communications link wherein the second antenna means is configurable to be steered to aim towards the remote end of the wireless communications link; an antenna driver means configured to control an orientation or polarization of the second antenna means; and a comparator algorithm configured to evaluate a quality of one or more signals from each of the first antenna means and the second antenna means, compare at least one signal input from each of the first antenna means and the second antenna means to generate a feedback signal to instruct an antenna driver to steer the second antenna means towards a more preferred orientation or polarization, wherein the comparator algorithm determines a quality of each of a first input from the first antenna means and a second input from the second antenna means to identify which of the first input and the second input has a higher quality and further wherein if the first antenna signal has a higher quality, the first antenna signal is selected and a line feed is routed to an output where a set of search and optimization instructions are executed and the antenna driver means is adjusted to an orientation or polarization of the second antenna means, and if the second input from the second antenna has a higher quality then the second antenna signal is selected. In some configurations, the second antenna means is electronically steerable without the use of moving parts by the driver signal received from the antenna driver means. Additionally, the second antenna means may be physically steerable by actuating one or more actuators in response to the driver signal from the antenna driver means. The first antenna means can also be configured to plug into a housing containing the second antenna means. The second antenna means can also be steered through multiple degrees of freedom. The remote station can be a Wi-Fi access point or a remote station is a cellular base station.

Another aspect of the disclosure is directed to a tunable communication device comprising: an non-directional antenna means, in communication with a Wi-Fi access point having an unknown location generating a first signal; a second antenna means, in communication with the Wi-Fi access point, wherein the second antenna means is configured to be physically, angularly incremented and decremented to point towards the Wi-Fi access point generating a second signal; an antenna driver means configured to control an orientation of the second antenna means; and a comparator algorithm, configured to evaluate three or more of a current first signal quality, a prior first signal quality, a current second signal quality to a prior second signal quality to generate a feedback signal to an output based on a signal quality of the evaluated signals, wherein if the quality of either of the current first signal or prior first signal from the omnidirectional antenna means has a higher quality than either of the current second signal or prior second signal from the second antenna, one of the current first signal or prior first signal is selected as a line feed and routed to an output, and further wherein if the a set of search and optimization instructions are executed.

Yet another aspect of the disclosure is directed to methods of operating a tunable communication device comprising the steps of: receiving a first signal from a first antenna means; receiving a second signal from a second antenna means; determining a quality of the first signal and a quality of the second signal; outputting a feed of a higher quality signal selected from the first signal and the second signal; and wherein if the first signal is selected an optimization protocol is performed. Additionally, the methods can include: (a) altering a direction or polarization of the second antenna means; (b) receiving a subsequent signal from the second antenna means; and (c) determining a quality of the subsequent signal from the second antenna means, wherein if a quality of the subsequent signal of the second antenna means is lower than the quality of the signal from the first antenna means, repeating steps (a) through (c). In some aspects of the methods, a second antenna orientation angle can be incrementally refined when the signal quality of the first antenna is equal to or greater than the signal quality of the second antenna means. Additionally, the methods can include monitoring a relative quality of the second antenna signal and the first antenna signal, wherein if the first antenna signal strength exceeds the second antenna signal strength the step of analyzing is repeated.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example, US 2006/0044112 A1 published Mar. 2, 2006, to Bridgelall for Wearable RFID Reader and System; US 2007/0253395 A1 published Nov. 1, 2007, to Graves for Wireless Network Detector; US 2007/0275664 A1 published Nov. 29, 2007, to Uhl for Method and System for Improving Wireless Link Performance; U.S. Pat. No. 6,018,646 A issued Jan. 25, 2000, to Myllymaki et al. for Power Consumption Monitor and Alarm for a Mobile Means of Communication; U.S. Pat. No. 6,542,083 B1 issued Apr. 1, 2003, to Richley et al. for Electronic Tag Position Detection Using Radio Broadcast; U.S. Pat. No. 6,611,696 B2 issued Aug. 26, 2003 to Chedester et al. for Method and Apparatus for Aligning the Antennas of a Millimeter Wave Communication Link Using a Narrow Band Oscillator and a Power Detector; U.S. Pat. No. 7,005,980 B1 issued Feb. 28, 2006, to Schmidt for Personal Rescue System; U.S. Pat. No. 7,696,887 B1 issued Apr. 13, 2010, to Echavarria, for Personal Tracking and Communication System; U.S. Pat. No. 7,764,171 B2 issued Jul. 27, 2010, to Cheng et al. for Adjusting a Communications Channel Between Control Unit and Remote Sensor; U.S. Pat. No. 8,519,906 B2 issued Aug. 27, 2013, to Richards et al. for Locating System; U.S. Pat. No. 8,892,049 B2 issued Nov. 18, 2014 to Rosenblatt et al. for Handheld Electronic Devices with Antenna Power Monitoring; U.S. Pat. No. 8,909,190 B2 issued Dec. 9, 2014, to Carson for Portable Wireless Compatibility Detection, Location and Communication Device; U.S. Pat. No. 8,947,528 B2 issued Feb. 3, 2015, to Hinman et al. for Container Classification Identification Using Directional-Antenna RFID; U.S. Pat. No. 9,000,887 B2 issued Apr. 7, 2015 to Linsky et al. for Method and Apparatus for Communicating Control Information by a Wearable Device to Control Mobile and Consumer Electronic Devices; and U.S. Pat. No. 9,024,749 B2 issued May 5, 2015 to Ratajczyk for Tactile and Visual Alert Device Triggered by Received Wireless Signals.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, where:

FIG. 1 is a high level block diagram that illustrates and operation of a device according to the disclosure;

FIG. 2 illustrates an exemplary signal quality comparator algorithm which shows an operation of an exemplar signal quality comparator algorithm as described as a finite state machine, to explain states and how they switch;

FIG. 3 illustrates a signal quality comparator algorithm in operation which provides a specific example in detail to show signal quality trigger points;

FIGS. 4-6 illustrate an outline of the search, refinement and maintenance algorithmic examples; and

FIG. 7 illustrates a kit which provides one commercial approach to the device which would allow retrofit of existing systems.

### DETAILED DESCRIPTION

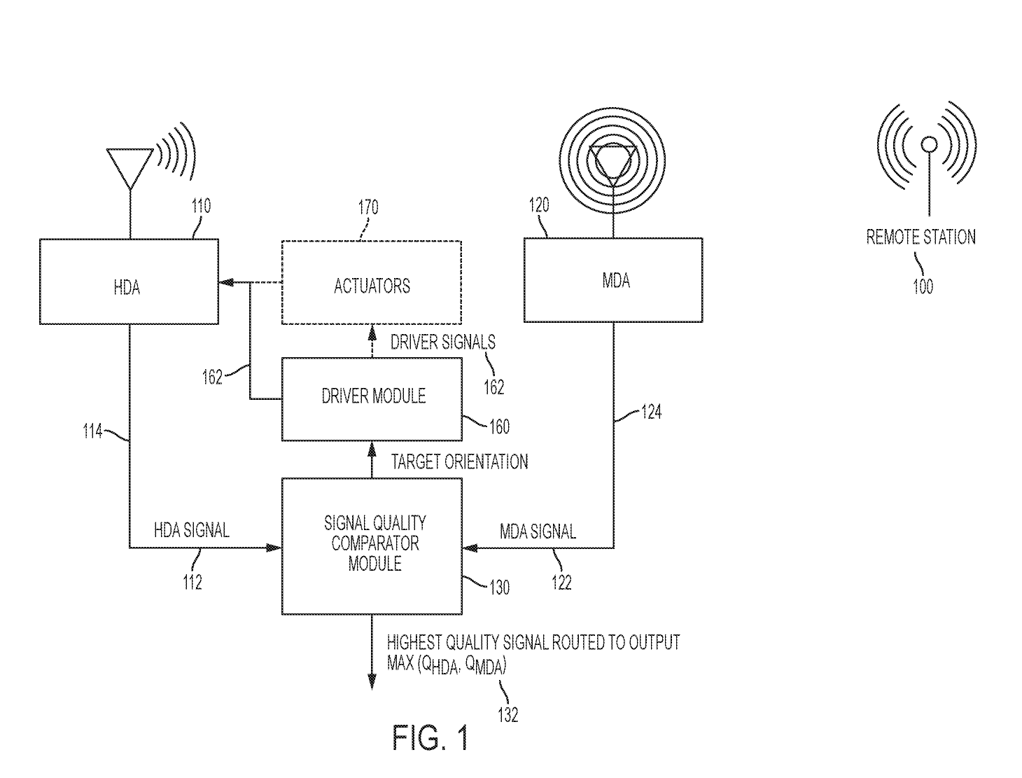

Referring now to FIG. 1, a high level block diagram of the system is presented. In the context of this communications system the remote station 100 represents the remote end of a wireless communications link, wherein the precise geographic position of the remote station 100 is unknown. Examples of the communications system this scheme may apply to include, for example, Wi-Fi 802.11 and cellular communications systems and any other systems having a remote wireless remote station.

The system described in the block diagram may consist of a fixed or moving system, wherein the remote station 100, comprising a Wi-Fi remote station or cellular base station, is at an unknown location and orientation relative to the system. The system can arrive at a higher quality signal than that which can be resolved from a minimally directional antenna such as an omnidirectional antenna (a first antenna or first antenna sub-system). Note that the maximum speed permissible for the disclosed system to still function is limited by the speed of the system's ability to converge to and lock onto an orientation that keeps the signal quality of the directional antenna generally above the minimally directional antenna.

A minimally directional antenna (MDA) 120, or non-directional antenna (NDA), can function as one of two antenna sub-systems in an overall system. MDA 120 may be implemented as any antenna with little or no directionality, for instance a standard, readily available omnidirectional antenna. An antenna line feed connects to a signal quality comparator module 130 as one of two concurrent line feeds the comparator takes in as input. As illustrated, the highly directional antenna (HDA) 110, or directional antenna (DA), has an HDA signal 112 which feeds into the signal quality comparator module 130 via an HDA line feed 114, and the MDA 120 has an MDA signal 122 which feeds into the signal quality comparator module 130 via an MDA line feed 124. The difference in the gain between the two antennas is typically 3 dB or greater. Each of the antennas receives an incoming RF energy input and produces a conducted output signal which is sent to the signal quality comparator module 130 and is received as an input from the MDA 120 or the HDA 110. The quality of the conducted output signal from each of the antennas is used to determine which antenna to use.

The second antenna sub-system consists of a highly directional antenna (HDA) 110, such as directional antenna (DA), which can be physically or electronically steered by driver mobile to receive and transmit a signal from any orientation permissible within its design (a second antenna). An example of an electronic steering HDA is via multiple antennas implementing a beam forming strategy for instance in 802.11 AC protocol.

In operation, the HDA 110 can eventually be steered to a relative orientation which is optimized towards the remote station 100 in order to attain a higher quality signal than the MDA 120. The system can also dynamically adapt to a changing signal quality and orientation. The HDA signal 112 feeds into the signal quality comparator module 130.

Signal quality comparator module 130 may be implemented purely in hardware, as software for instance in a microcontroller, or some hybrid of the two, as desired.

At a high level, the signal quality comparator module 130 accepts the HDA signal 112 and the MDA signal 122 as antenna line feeds 114, 124 from HDA 110 and MDA 120, respectively, and then compares the signal quality for the HDA signal 112 and the MDA signal 122. Thereafter a quality comparator module output 132 is generated which provides an output of the feed which possesses the highest signal quality to the driver module 160.

If the HDA signal 112 has a lower quality than the MDA signal 122, signal quality comparator module 130 implements one of a diversity of algorithms to engage driver module 160 to reorient the HDA 110 to point the HDA 110 towards the remote station 100, according to any of a diversity of signal optimization schemes, for instance, by steering the HDA 110 beam in increments and decrements as part of a control loop.

The signal quality comparator module 130 may use any number of schemes to determine which signal has the best quality of the two antennas providing signal input to the comparator module. This may include, for instance, magnitude, code correlation or some combination thereof. The system makes a direct comparison between the two signals analyzed to determine which signal should be used and can continue to adjust by further scanning back and forth in smaller increments, to find the maximum difference between the two signals.

The signal quality comparator module 130 is configurable to indirectly adjust an orientation of HDA 110 via the driver module 160. Driver module 160 may be implemented purely in hardware, as software for instance in a microcontroller, or some hybrid of the two. Driver module 160 is configurable to receive from the signal quality comparator module 130 a control signal corresponding to a target orientation, which the driver module 160 then maps onto necessary time-variant driver signals required to drive either the HDA 110 directly in the case of an electronically steerable beam, or indirectly via control of actuators 170, which drive the physical reorientation of the HDA 110. Actuators can be powered by any suitable means including, for example, a high voltage AC power source, manual manipulation, etc.

Driver module 160 can convert a target orientation into a drive signal 162 required to drive a position of the HDA 110 to achieve the target orientation for the HDA 110. The drive signal 162 can be directly communicated to the HDA 110. Alternatively, in the case where HDA 110 requires physical movement to reorient the antenna, actuators 170 can be utilized. Actuators 170 may be any of the actuator types in use, including electric motors, pneumatic, hydraulic or other means for generating movement controlled by electrical signals. Depending on the application, the antenna can be steered through 1 to 3 degrees of freedom. For example, a satellite would use 3 degrees of freedom.

Once the driver module 160 has caused the HDA 110 to update its orientation to the target orientation, a complete loop has been made and the HDA signal 112 from the HDA 110 at this new orientation follows the same prior feed line into the signal quality comparator module 130 to measure its relative quality against MDA 120 signal quality.

The aforementioned feedback loop allows for a diversity of search and signal quality optimization algorithms to converge on the best possible signal for a given placement of the disclosed device.

Specific applications include:

TABLE 1
APPLICATIONS

| Pointing X where X is | at a Y where Y is |
|---|---|
| Radio | Radio station |
| TV | TV Station |
| Satellite | Satellite |
| Marine Radio | Naval or Coast Guard Transmitter |
| Wifi | Wifi transmitter |
| Cellular | Cellular Transmitter |
| Receiving | Transmitter Antenna |

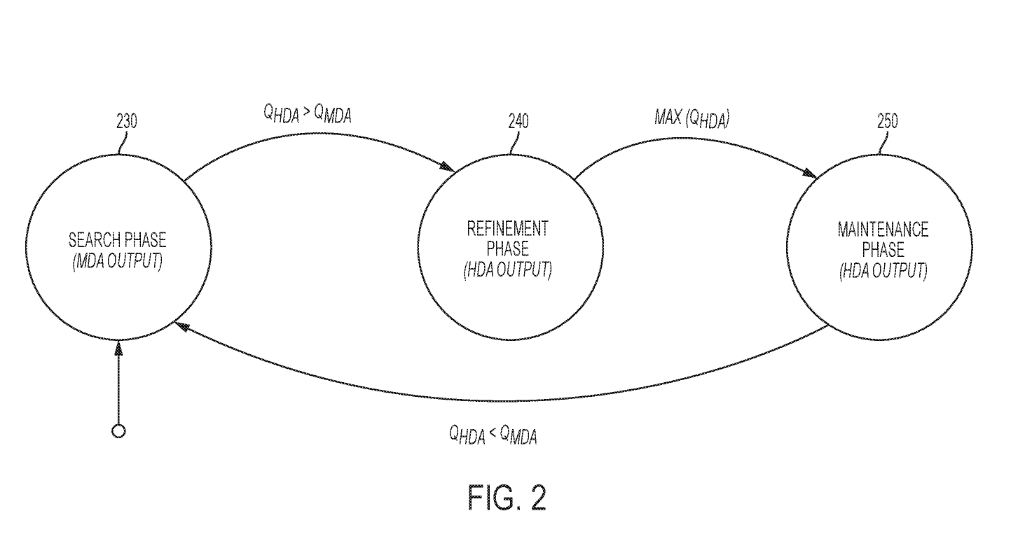

FIG. 2 presents one high level example of how the signal quality comparator module algorithm may be implemented. In this example, the module is in one of three states: search phase 230, refinement phase 240, or maintenance phase 250.

Hereafter, for ease of description, signal quality of HDA and MDA signals will be represented as Q_{HDA} and Q_{MDA}, respectively. Similarly line feed signal of HDA and MDA will be represented as S_{HDA} and S_{MDA} respectively and HDA orientated to an angle ‘a’ can be represented as HDA(a).

The initial state of the signal quality comparator module 130 (FIG. 1) is illustrated in FIG. 2 is the search phase 230, whereby S_{MDA} line feed is routed to output. In this state, HDA orientation is adjusted according to any number of search algorithms, for instance, the simple incrementing of the beam angle, until Q_{HDA} exceeds Q_{MDA}.

Once Q_{HDA}>Q_{MDA}, two actions are triggered. First, S_{HDA}, being now the signal of the highest quality, is the signal routed to module output. Secondly, the state of the system then switches to refinement phase 240.

In refinement phase 240, the orientation of the HDA is adjusted according to any number of signal optimization schemes, for instance, simple incrementing of HDA orientation angle, until the angle for maximizing Q_{HDA} has been identified.

Since system can only enter refinement state if HDA is of higher quality than MDA, S_{HDA} is unconditionally routed to module output while module is in this state.

Once the orientation which maximizes Q_{HDA} has been identified, the module switches states again to maintenance phase 250.

The signal quality comparator module 130 (FIG. 1) spends most of its operational time in maintenance phase 250 as it is the intention of the search scheme in search phase 230 and of the signal optimization scheme in refinement phase 240 to both respectively converge on their target objective in as minimal time as possible.

To enter maintenance phase, Q_{HDA} must be both greater than Q_{MDA} and also be at an orientation which maximizes its own signal quality. The objective in maintenance phase 250, therefore, is to maintain HDA at the preset optimal orientation while also monitoring relative quality of MDA.

While in maintenance phase 250, S_{HDA} line feed remains the signal routed to module output.

In the event that Q_{HDA} again drops below Q_{MDA}, then this triggers two actions. First, now that S_{MDA} is the highest quality signal, S_{MDA} is now the line feed routed to module output. Secondly, module next switches states back to search phase 230 to again find an orientation for HDA where Q_{HDA}>Q_{MDA}, hence repeating the cycle.

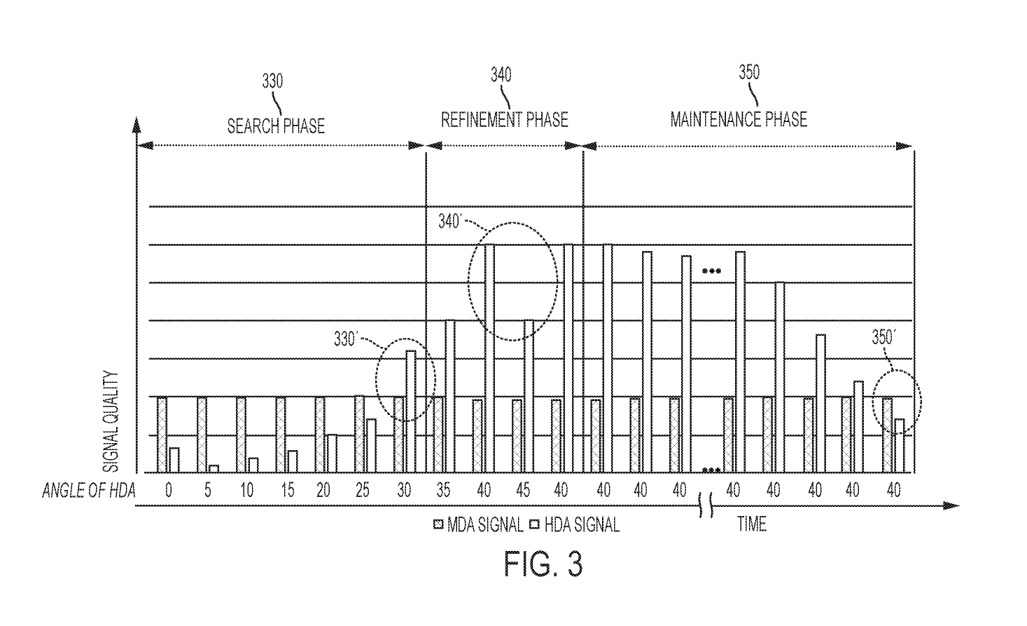

FIG. 3 illustrates an example of how the signal quality comparator algorithm can be implemented. The time-based chart is divided into three successive regions; search phase 330, refinement phase 340 and maintenance phase 350, together representing the three distinct phases of this implementation. After maintenance phase 350 on the far right, the state would switch back to again to a new search phase.

The (horizontal) time axis on this chart depicts an actual use case scenario where two distinctly measured signal quality levels (vertical axis), from MDA (light-shaded) and HDA (dark shaded) lead to triggering of state changes.

MDA signal quality across time in this scenario is more or less constant as would be expected for an MDA such as an omnidirectional antenna. By contrast, HDA quality varies by orders of magnitude, based on its angle. In this chart, angle of HDA is provided at the base of the chart to demonstrate angular increments. In this chart the angle of HDA is arbitrarily shown to increment by 5 degrees for convenience of illustration, however increments may be of much smaller size in order to arrive at best possible signal quality for HDA.

Signal events which cause state to transition to a different state are encircled by a dotted ellipse. Starting from the search phase, at the leftmost end of the chart, where HDA angle is arbitrarily set to 0, the signal quality of HDA is shown to be substantially less than signal quality of MDA. HDA angle, in accordance with search phase algorithm, is increased by equal angular increments until at HDA angle of 30 degrees resulting in a search phase signal quality 330′ Q_{HDA} exceeds Q_{MDA} and the system switches states to refinement phase 340.

In refinement phase 340, according to this particular refinement phase algorithm, HDA angle ‘a’ is continually incremented, where corresponding Q_{HDA(a)} is measured to have increased. In this chart, at an angle of 45 degrees the HDA signal quality final drops to a refinement phase signal quality 340′, indicating the immediate past increment was the angle which maximized signal quality.

Once the HDA quality maximizing angle is known, the algorithm resets the angle back to the maximizing angle, in this scenario, 40 degrees. Once this maximizing angle is set, the module switches states to maintenance phase 350. In maintenance phase, according to this particular version of the maintenance phase algorithm, the HDA angle is held constant and the relative signal quality of the two antennas is monitored. The monitoring phase is typically the state the module spends most of its operating time in.

Eventually, when the relative superiority of Q_{HDA} degrades such that MDA now provides the best quality signal, the maintenance phase signal quality 350′, this indicates the HDA is no longer optimally positioned towards the remote station, and the module again switches states, this time back to a new search phase state to find a new optimal angle by incrementing current HDA angle and following the search phase algorithm as before.

FIG. 3 illustrates how at worst case, the disclosed device outputs signal quality of an MDA, e.g. an omnidirectional antenna, and at the best, provides much higher signal quality from a high gain directional antenna aimed directly at an remote station of hitherto unknown location.

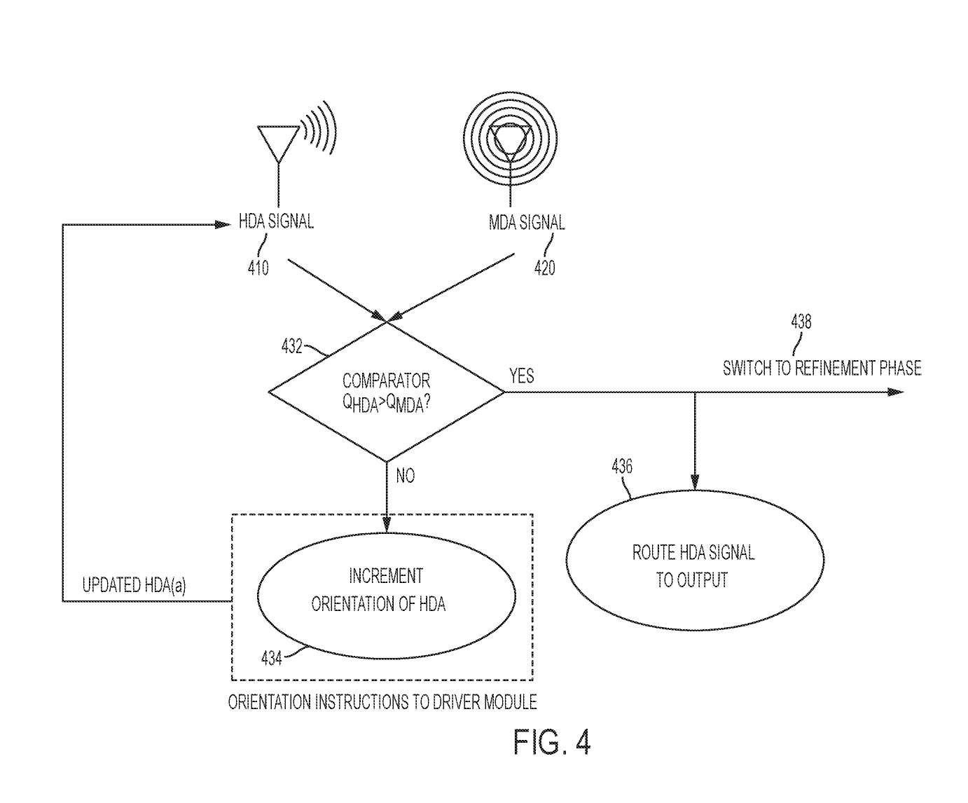

FIG. 4 to FIG. 6 describe a version of the search, refinement and maintenance phase algorithms in further detail to illustrate one way each module can be implemented.

Turning now to FIG. 4, the high level objective is to alter HDA orientation angle ‘a’ until Q_{HDA(a)}>Q_{MDA}.

HDA signal 410 (S_{HDA}) and MDA signal 420 (S_{MDA}) feed in to the comparator 432, which tests Boolean expression Q_{HDA(a)}>Q_{MDA}. If the expression is false (NO) then module increments ‘a’ via new orientation signal to driver module 434. An updated HDA(a) signal is sent to HDA signal 410. An updated S_{HDA} is then fed back into comparator 432 for reevaluation. This process can occur in a continual iterative loop. If expression evaluates to true (YES), then S_{HDA} is deemed of the higher signal quality and is selected as the one line feed to route to output 436 before module switches states to refinement phase 438.

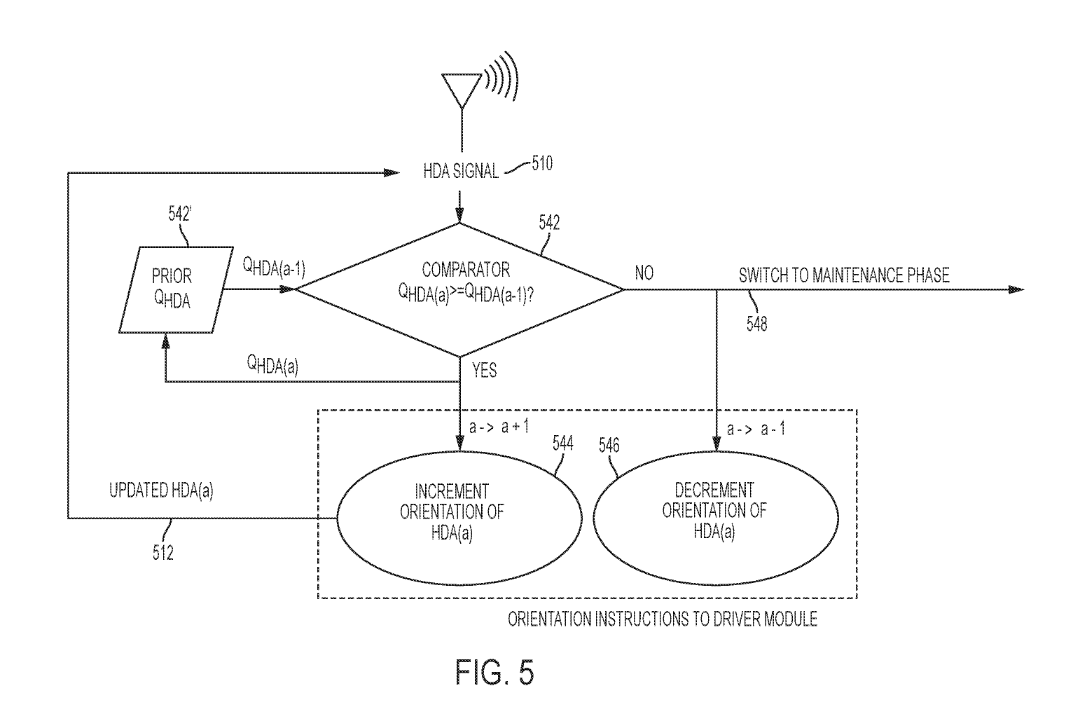

FIG. 5 describes one version of an algorithm which implements the refinement phase (corresponding to refinement phase 240 of FIG. 2). A high level objective of the refinement phase is to arrive at an orientation which maximizes Q_{HDA}. In the example implementation described, S_{HDA} is the only line feed used in evaluation and angle ‘a’ represents the orientation variable of HDA.

A line feed of the HDA signal 510 S_{HDA}, enters comparator 542 for evaluation where Q_{HDA(a)} is compared with immediately prior Q_{HDA(a-1)} 542′. If expression Q_{HDA(a)}≧Q_{HDA(a-1)} evaluates to true (YES), then two actions result. First, current Q_{HDA(a)} is saved in prior Q_{HDA} 542′, and second the next increment orientation instructions 544 are sent to driver module, resulting in an updated S_{HDA(a)} 512 which in the next loop iteration can again be reevaluated by the comparator 542.

If the comparator 542 expression evaluates to false (NO), two actions result. First, instructions are sent to driver module to decrement ‘a’ back to the immediately prior angle which maximized Q_{HDA} 546. Secondly, having maximized Q_{HDA}, the module switches states to maintenance phase 548 (corresponding to maintenance phase 250 in FIG. 2).

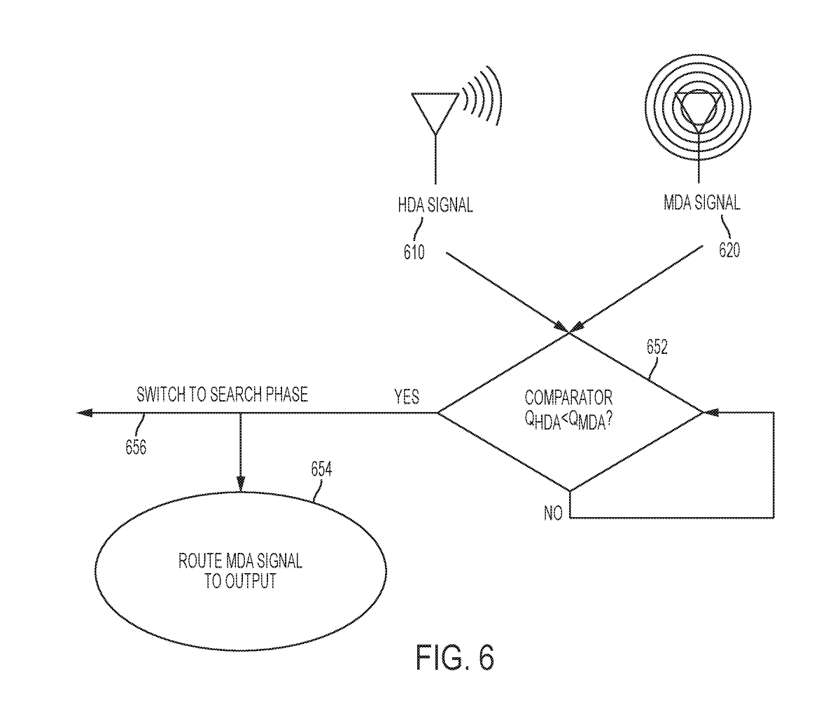

FIG. 6 describes one version of an algorithm which implements the maintenance phase. The high level objective of the maintenance phase is to maintain HDA at the orientation which was found to maximize Q_{HDA}, and by continual monitoring, switch back to search phase if Q_{HDA}<Q_{MDA}. In the example implementation described, there is no movement or control of HDA. Both S_{HDA} 610 and S_{MDA} 620 are fed into a comparator function 652 to evaluate the expression Q_{HDA}<Q_{MDA}.

If the comparator expression evaluates to false (NO), then the comparator continues monitoring the two line feeds. If the comparator operator evaluates to true (YES) then two actions result. First, S_{MDA} is now deemed of higher signal quality and is selected as the one line feed to route to output 654. Next, the module switches states back to the search phase 656 (corresponding to search phase 230 in FIG. 2) to reinitiate the process of finding an angle which optimizes Q_{HDA}.

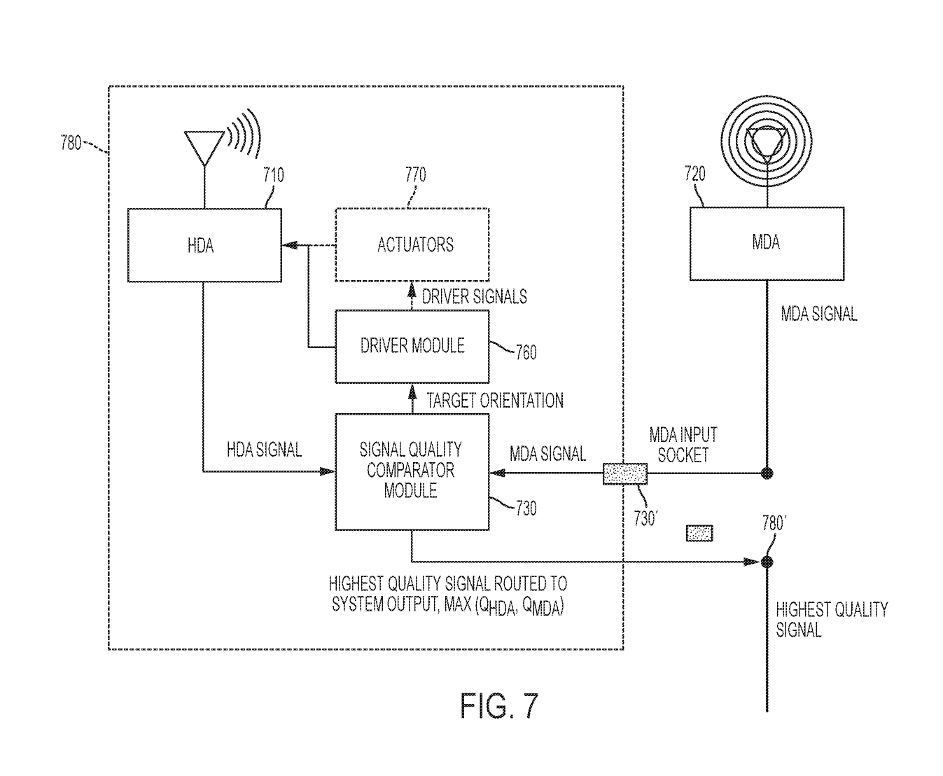

FIG. 7 provides an example of one of many possible ways the system can be commercially packaged. In this example, HDA 710, signal quality comparator module 730, driver module 760 and any actuators 770 all comprise a single physical module package which can be sold, leased or licensed as part of a specialized, self-optimizing HDA kit.

The self-optimizing HDA kit is installed as an enhancement for MDA antenna operating on its own. Installation is conducted by first unplugging the existing MDA 780′ line feed from its former line-in, and instead plugging in MDA feed directly into a socket on the MDA kit 730′, electrically connected to MDA line-in for the signal quality comparator module 730. The HDA kit line-out can then plug directly into the line-in previously utilized by MDA 780′. In this way, the HDA kit can be retrofitted with any MDA system and the HDA kit will always output the highest quality signal between the HDA 710 and MDA 720.

### Example 1

When the system is used in a satellite, the system can be configured to increment a rotation of 5 degrees clockwise through 360 degrees, then increments 5 degrees of elevation and then increments back through 360 degrees counter-clockwise, before repeating the elevation gain and the rotation again, if necessary. The assumption is that the radio in question can listen to both non-directional antenna (NDA) and directional antennas (DA) at the same time so as to compare and the received signal quality of the same incoming packet between the two antennas. If the signal output quality of the NDA that is received as a signal input by the signal quality comparator is better than the signal output quality of the DA that is received as a signal input by the signal quality comparator, then the DA is adjusted in orientation or polarization until the signal quality of the DA is greater than the NDA.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A tunable communication device comprising:
a first antenna having a first directionality, in communication with a remote end of a wireless communications link having an unknown location;
a second antenna having a second directionality greater than the first directionality, in communication with the remote end of the wireless communications link wherein the second antenna is configurable to be steered to one of a pre-defined orientation wherein at least one of the pre-defined orientations aims towards the remote end of the wireless communications link;
an antenna driver configured to control an orientation of the second antenna; and
a comparator algorithm configured to evaluate a quality of one or more input signals from each of the first antenna and the second antenna and to compare at least one input signal from each of the first antenna and the second antenna to generate a route signal to instruct the antenna driver to steer the second antenna towards an orientation,
wherein the comparator determines a quality of each of a first input from the first antenna and a second input from the second antenna to identify which of the first input and the second input has a higher quality and further wherein if the first input from the first antenna has a higher quality, the first antenna signal is selected and a line feed is routed to an output where a set of search and optimization instructions are executed and the antenna driver is adjusted to an orientation of the second antenna, and if the second input from the second antenna has a higher quality then the second antenna signal is selected.

2. The tunable communication device of claim 1 wherein the second antenna is electronically steerable without the use of moving parts by the driver signal received from the antenna driver.

3. The tunable communication device of claim 1 wherein the second antenna is physically steerable by actuating one or more actuators in response to the driver signal from the antenna driver.

4. The tunable communication device of claim 1 wherein the first antenna is configured to plug into a housing containing the second antenna.

5. The tunable communication device of claim 1 where the second antenna can be steered through multiple degrees of freedom.

6. The tunable communication device of claim 1 where the remote station is a Wi-Fi access point.

7. The tunable communication device of claim 1 where the remote station is a cellular base station.

8. A tunable communication device comprising:
an omnidirectional antenna, in communication with a Wi-Fi access point having an unknown location generating a first signal;
a second antenna, in communication with the Wi-Fi access point, wherein the second antenna is configured to be physically, angularly incremented and decremented to point the second antenna towards the Wi-Fi access point generating a second signal;
an antenna driver configured to control an orientation of the second antenna; and
a comparator configured to evaluate three or more of a current first signal quality, a prior first signal quality, a current second signal quality, and a prior second signal quality to generate a route signal for an output based on a signal quality of the evaluated signals,
wherein if the quality of either of the current first signal or prior first signal from the omnidirectional antenna has a higher quality than either of the current second signal or prior second signal from the second antenna, one of the current first signal or prior first signal is selected as a line feed and routed to the output, and further wherein a set of search and optimization instructions are executed.

9. A method of operating a tunable communication device comprising the steps of:
receiving a first signal from a first multidirectional antenna;
receiving a second signal from a second directional antenna;
determining a quality of the first signal and a quality of the second signal;
outputting a feed of a higher quality signal selected from the first signal and the second signal; and
wherein if the first signal is selected an optimization protocol is performed.

10. The method of claim 9 further comprising the step of:
(a) altering a direction of the second antenna;
(b) receiving a subsequent signal from the second antenna; and
(c) determining a quality of the subsequent signal from the second antenna,
wherein if the quality of the subsequent signal of the second antenna is lower than the quality of the signal from the first antenna, repeating steps (a) through (c).

11. The method of claim 9 further comprising the step of:
incrementally refining a directional antenna orientation angle when the signal quality of the first antenna is equal to or greater than the signal quality of the second antenna.

12. The method of claim 9 further comprising the step of:
monitoring a relative quality of the second antenna signal and the first antenna signal, wherein if the first antenna signal strength exceeds the second antenna signal strength the step of analyzing is repeated.

13. A tunable communication device comprising:
a first antenna means having a first directionality, in communication with a remote end of a wireless communications link having an unknown location;
a second antenna means having a second directionality greater than the first directionality, in communication with the remote end of the wireless communications link wherein the second antenna means is configurable to be steered to one of a pre-defined orientation wherein at least one of the pre-defined orientations aims towards the remote end of the wireless communications link;
an antenna driver means configured to control an orientation of the second antenna means; and
a comparator algorithm configured to evaluate a quality of one or more signals from each of the first antenna means and the second antenna means and to compare at least one signal input from each of the first antenna means and the second antenna means to generate a route signal to instruct the antenna driver means to steer the second antenna means towards an orientation,
wherein the comparator determines a quality of each of a first input from the first antenna means and a second input from the second antenna means to identify which of the first input and the second input has a higher quality and further wherein if the first input from the first antenna has a higher quality, the first antenna signal is selected and a line feed is routed to an output where a set of search and optimization instructions are executed and the antenna driver means is adjusted to an orientation of the second antenna means, and if the second input from the second antenna has a higher quality then the second antenna signal is selected.

14. The tunable communication device of claim 13 wherein the second antenna means is electronically steerable without the use of moving parts by the driver signal received from the antenna driver means.

15. The tunable communication device of claim 13 wherein the second antenna means is physically steerable by actuating one or more actuators in response to the driver signal from the antenna driver means.

16. The tunable communication device of claim 13 wherein the first antenna means is configured to plug into a housing containing the second antenna means.

17. The tunable communication device of claim 13 where the second antenna means can be steered through multiple degrees of freedom.

18. The tunable communication device of claim 13 where the remote station is a Wi-Fi access point.

19. The tunable communication device of claim 13 where the remote station is a cellular base station.

20. A tunable communication device comprising:
an omnidirectional antenna means, in communication with a Wi-Fi access point having an unknown location generating a first signal;
a second antenna means, in communication with the Wi-Fi access point, wherein the second antenna means is configured to be physically, angularly incremented and decremented to point the second antenna towards the Wi-Fi access point generating a second signal;
an antenna driver means configured to control an orientation of the second antenna means; and
a comparator configured to evaluate three or more of a current first signal quality, a prior first signal quality, a current second signal quality, and a prior second signal quality to generate a route signal for an output based on a signal quality of the evaluated signals,
wherein if the quality of either of the current first signal or prior first signal from the omnidirectional antenna means has a higher quality than either of the current second signal or prior second signal from the second antenna, one of the current first signal or prior first signal is selected as a line feed and routed to the output, and further wherein a set of search and optimization instructions are executed.

21. A method of operating a tunable communication device comprising the steps of:
receiving a first signal from a first antenna means;
receiving a second signal from a second antenna means;
determining a quality of the first signal and a quality of the second signal;
outputting a feed of a higher quality signal selected from the first signal and the second signal; and
wherein if the first signal is selected an optimization protocol is performed.

22. The method of claim 21 further comprising the step of:
(a) altering a direction of the second antenna means;
(b) receiving a subsequent signal from the second antenna means; and
(c) determining a quality of the subsequent signal from the second antenna means,
wherein if the quality of the subsequent signal of the second antenna means is lower than the quality of the signal from the first antenna means, repeating steps (a) through (c).

23. The method of claim 21 further comprising the step of:
incrementally refining a second antenna orientation angle when the signal quality of the first antenna is equal to or greater than the signal quality of the second antenna means.

24. The method of claim 21 further comprising the step of:
monitoring a relative quality of the second antenna signal and the first antenna signal, wherein if the first antenna signal strength exceeds the second antenna signal strength the step of analyzing is repeated.
